(19) United States
(12) Patent Application Publication
(10) Pub. No.: US 2002/0120932 A1
(43) Pub. Date: Aug. 29, 2002

(54) Omni menu for an audio/visual network

(76) Inventor: Eddie M. Schwalb, Irvine, CA (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/795,723

(22) Filed: Feb. 28, 2001

(51) Int. Cl. H04N 7/16

(52) U.S. Cl. 725/37; 725/139

(57) ABSTRACT

The present invention combines all menus of all appliances (e.g., including the set-top-box, TV, and networking devices), all available services (whether selected or not), all available events (including co-branded and promoted events), all available channels, and all promoted material into a single, unified interface or OmniMenu. In this regard, the user has immediate and easy access to and control of all content information contained within a consumer electronics network environment, whether that content information stems from a broadcast, from an appliance itself, from an informational service such as the Internet, or from the user himself/herself. The present invention defined menu API enables all appliances and broadcast applications to register and construct their individual menus to collectively assemble the single OmniMenu. The OmniMenu assembly is achieved through a uniform menu API, wherein the menu API enables all controlled hardware, software, and content components to collectively construct the unified view of the available services, and present this view within a single menu. This menu can be updated in real-time, on-the-fly, as new appliances are connected, or the broadcast data services change.

### BACKGROUND

1. Field of the Invention

The present invention relates to a graphical user interface menu for home appliances. Specifically, the present invention relates to menus and user-interfaces of home appliances and consumer electronics devices; and even more specifically, those developed in the context of the Digital TV Application Software Environment (DASE). The present invention eliminates the need for confusing, error-prone, and time-consuming browsing of digital TV broadcasts by assembling a single unified and intuitive menu.

2. Background

Consumer electronic devices present numerous options and features that may be controlled by a user to both enhance and customize the performance of the device. Moreover, due to the increasingly complex nature of these devices as technology expands and reaches new heights, more emphasis must be placed on providing a user-friendly interface whereby a user may easily control the device and its available functions to optimize the device's performance. As such, one of the best ways found to accomplish this is through the introduction of hierarchal, menu-based interfaces. However, because of the increasing complexity inherent in today's devices as technology reaches new heights, these menus have become entirely too complex in their own right.

Moreover, to compound the problem, many users face the problem of combining several devices into a network such as a digital television network. It is not uncommon for a user to network together multiple devices, each performing significantly different functions. As each device comes equipped with its own menu system, it becomes extremely burdensome and time-consuming to sift through the various formats and layouts associated with each device to optimize the usage of the device within the networked environment.

Moreover still, the use of digital TV broadcast renderers, also known as Set Top Boxes, often involves complicated selection of configurations, profiles, and service offerings. The inexperienced user, or experienced user having time pressure, may find the operation of various menus and selectors equally confusing, error-prone, and time-consuming.

Prior art audio and video appliances can often be configured using a TV control menu presented on a TV display. This menu can be generated and provided by the appliance, as defined by the HAVI standard. The HAVI architecture is explained in greater detail below. In essence however, the HAVI architecture allows several components, appliances, and hardware devices to communicate with one another within a supporting network.

However, as mentioned above, the HAVI architecture requires that each appliance will be associated with its own menu, and sometimes a single appliance will have multiple menus. Current plans for digital TV content include a separate menu of available applications for each channel, thus complicating and increasing the complexity of the menu system or environment even more.

U.S. Pat. No. 6,052,554 discloses menus, which are partially stored in a set top terminal in each subscriber's home and may be reprogrammed by signals sent from the operations center or headend. Numerous types of menus may be used, incorporating information included within the video/data signal received by the set top terminal. A remote control unit with icon buttons allows a subscriber to select programs based upon a series of major menus, submenus, and during program menus. Various data gathering and analysis techniques are used to compile programs watched information that in turn is used in packaging programs, customizing menu selections, targeting advertisements, and maintaining account and billing information. This system and method, however, does not provide the capability to assemble a single unified menu from which anything and everything is accessible.

Accordingly, what is needed is a simplified menu environment or interface wherein a network of appliances or connected devices, as well as any other informational content components, may be assimilated into a unified menu such that the user may access any available content information pertaining to the network and the devices connected therein.

### SUMMARY AND OBJECTS OF THE INVENTION

The present invention focuses in the human appliance interface (HAI) issues raised when presenting end-users with control of sophisticated home appliances. There is a need for a clear and simple mental model that is implemented through a simple intuitive control system. This need is magnified in the case of digital broadcast renderer, e.g., a DASE-compliant set-top-box, since in addition to the configuration of numerous appliances, e.g., including the set-top-box itself, there is a need to browse through the digital broadcast to determine which services are available and activate one such service. The said browsing involves browsing through multiple channels and reviewing all the application available from each channel. Clearly, such browsing is time consuming, potentially confusing, and error prone, e.g., in the case hundreds of channels are available, each delivering several services.

The present invention combines all menus of all appliances (e.g., including the set-top-box, TV, and networking devices), all available services (whether selected or not), all available events (including co-branded and promoted events), all available channels, and all promoted material into a single, unified interface or OmniMenu. In this regard, the user has immediate and easy access to all content information contained within a consumer electronics network environment, whether that content information stems from a broadcast, from an appliance itself, from an informational service such as the Internet, or from the user himself/herself.

The OmniMenu of a preferred embodiment of the present invention enables controlling (1) the setting and control of networked appliances (e.g., font), (2) a guide to current programs (i.e., EPG for current programs only), (3) information and internet services available, including those not originating from the broadcast, and (4) a set favorites. Category 1 is controlled by the appliance and is automatically updated as they are connected or disconnected. Category 2 is controlled by the broadcast only. Category 3 is controlled by the set-top-box manufacturer, as well as by the broadcasters (e.g., promotions). Category 4 is controlled by the user.

The present invention defined menu API enables all appliances and broadcast applications to register and construct their individual menus to collectively assemble a single OmniMenu. The OmniMenu assembly is achieved through a uniform menu API, wherein the menu API enables all controlled hardware, software, and content components to collectively construct the unified view of the available services, and present this view within a single menu. This menu can be updated in real-time, on-the-fly, as new appliances are connected, or the broadcast data services change.

Contained within the OmniMenu is a series of submenus. The submenus correspond to and are synched with the various content providers within the network. The content providers of the present invention may be defined as and comprise any of the networked components or devices, the broadcast information, informational services, and any other information source available and capable of existing within the network over which control is needed, such control originating or existing in the user, the broadcaster, or the appliance or content provider itself. In a preferred embodiment, the OmniMenu would comprise submenu types as: appliance control, broadcast content control, informational services control, and end-user control.

As each device is introduced into the network it is identified and controlled using technology known in the art. However, rather than utilizing the menus of the specific entities or content providers, an OmniMenu is created using the menu API. Each content provider, such as an appliance, contains individual menu items that are identified and classified as to their function. In turn, these menu items each contain content information pertaining to a feature of the corresponding content provider. For example, as a new appliance is added to the network, its individual menu items are identified and classified as to what function they control. Subsequently, these menu items are added to the correct submenu within the OmniMenu architecture. Once the menu items are added, the submenu is activated and can be accessed and controlled. The addition of the various submenus and menu items, and the activation of the submenus is discussed in greater detail below.

Therefore, an object of the preferred embodiment of the present invention is to provide a single, unified network user interface enabling quick and efficient control of all content information within a networked environment.

Another object of the preferred embodiment of the present invention is to provide a single, unified menu for controlling the hardware and software of all appliances connected within the network environment.

A further object of the preferred embodiment of the present invention is to provide a single, unified menu capable of incorporating the content information of various devices and content sources.

A still further object of the preferred embodiment of the present invention is to provide a single, unified menu capable of controlling the broadcast content introduced within the networked environment.

A still further object of the preferred embodiment of the present invention is to provide a single, unified menu capable of controlling various informational services introduced within the networked environment.

A still further object of the preferred embodiment of the present invention is to provide a single, unified menu capable of enabling the user to customize the menu.

To achieve the foregoing objects, and in accordance with the invention as embodied and broadly described herein, the present invention features a digital broadcast network environment and a single, unified graphical user interface menu for controlling each content provider in the network. The assembly and construction of the single, unified graphical user interface menu is made possible through the use of the menu Application Program Interface.

The present invention further features a method for creating a single, unified graphical user interface menu to control consumer electronics within a networked environment.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates the preferred embodiment of the present invention showing the cluster of submenus and associated menu items along with the preview display window providing a preview of an identified highlighted menu item;

FIG. 2 illustrates a menu API message sequence for a content provider, such as an appliance, to add a menu item to the OmniMenu;

FIG. 3 illustrates the call sequence for adding a submenu to the OmniMenu;

FIG. 4 illustrates the individual menu item call sequence for adding an individual menu item to a submenu within the OmniMenu;

FIG. 5 illustrates the menu activation call sequence for activating and enabling a submenu and its associated menu items; and

FIG. 6 illustrates an alternate embodiment of the present invention wherein the OmniMenu may be used to display various types of information within a secondary display.

### DETAILED DESCRIPTION OF THE PREFERRED EMBODIMENTS

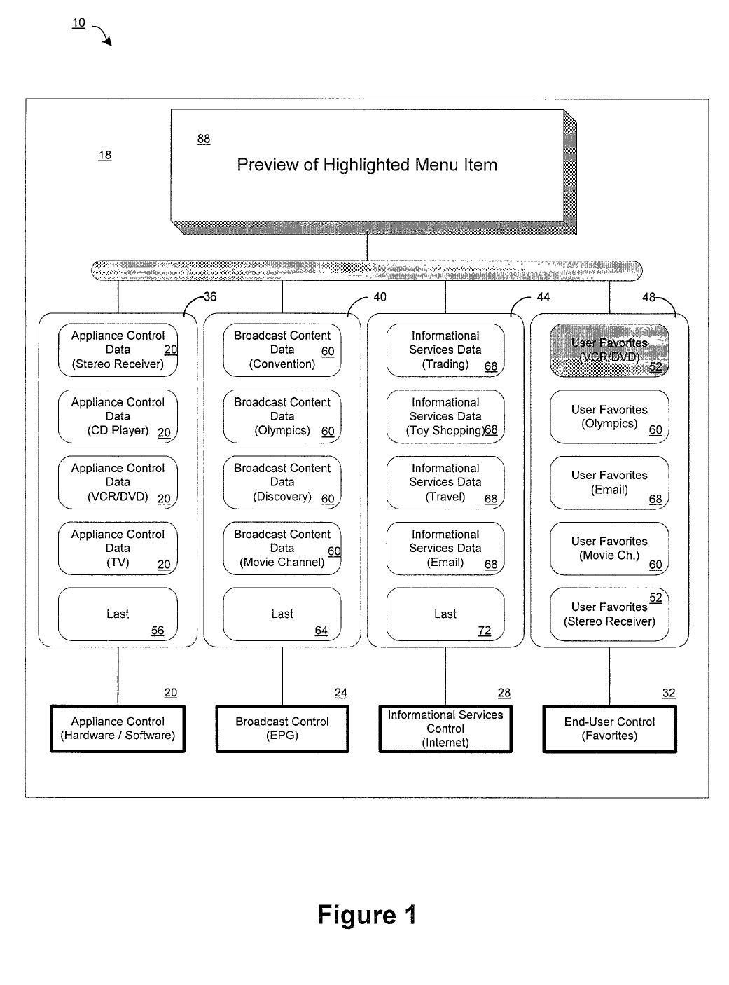

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, and components have not been described in detail as not to unnecessarily obscure aspects of the present invention. As such, the following more detailed description of the embodiments of the system and method of the present invention, and represented in FIGS. 1 through 6, is not intended to limit the scope of the invention, as claimed, but is merely representative of the presently preferred embodiments of the invention.

The presently preferred embodiments of the invention will be best understood by reference to the drawings, wherein like parts are designated by like numerals throughout.

### GENERAL DESCRIPTIONS AND DEFINITIONS

### HAVI Architecture

Embodiments of the present invention are operable within a consumer electronics network of the home audio/visual initiative (HAVI) architecture. Aspects of the HAVI architecture network (e.g., “HAVI architecture”) are discussed below to provide a general framework in which embodiments of the present invention operate.

The Architecture of the present invention enables the creation of a Home AV system which provides for seamless support of new devices and problem free interoperability of devices in a home AV network. The most basic components of a system in accordance with the present invention are: a home AV interoperability architecture, a series of home AV interoperability interfaces, and a home AV network. The home AV interoperability architecture is a broad, over arching term encompassing the physical network and the controlling programming interfaces. Interoperability interfaces is a term used to describe the interactions and interfaces of the components of the AV architecture. In addition to providing a common command set, the interoperability interfaces provide a software architecture which allows new devices to be integrated into the network and provide their services in a seamless manner. The home AV network is the term used to describe the physical network and its topology.

Specifically, the HAVI architecture provides: an execution environment supporting the visual representation and control of appliances; application and system services; and communication mechanisms for extending the environment dynamically through plug and play or otherwise.

HAVI is an architecture for inter-operating consumer electronics equipment devices adapted for the home network. The interoperability aspects define an architectural model that allows devices of any vendor to interrelate with one another and work within the home. A feature of the HAVI architecture is the combination of a base set of generic device controls (a device control software module) with a method to extend the base control protocol as new features and devices are deployed. The HAVI architecture supports a wide range of devices including intelligent receiver/decoders (IRDs), digital video tape records (DVTRs), video cassette recorders (VCRs), personal computers (PCs), digital video disk players (DVDs), etc., communicating via a common messaging system. Utilizing a physical port-to-port connecting configuration, several consumer electronics devices (“devices”) may be connected together with bus segments which couple (“plug into”) to ports on the respective devices. Typically the IEEE 1394 serial communication bus standard is used as a local bus platform to provide the common messaging system. The IEEE 1394 serial communication bus carries both commands, status information and well as digital audio and digital video signals between devices.

Through the use of a logical bus configuration within the HAVI network as described above, all of the devices connected in the HAVI network can be viewed as logically coupled to a common IEEE 1394 serial communication bus. Within this bus configuration, peer-to-peer device communication is supported. For example, any device having appropriate capabilities, such as a set-top-box, TV, or VCR, etc., can send or receive communication packets from any other device in the HAVI network. As applicable to the present invention, a Digital TV set-top-box (e.g., an DASE set-top-box) can receive messages from or generate messages to any of the other devices supported within the HAVI network.

The interoperability model in the HAVI architecture provides for the following: 1) support for existing devices; 2) a default control model; 2) a means to extend the default control model when new devices or functionality is brought to market; and 4) a common means for device representation (e.g., graphics user interfaces). To achieve the above, the HAVI architecture defines three types of nodes in the home network. A base AV (BAV) node is defined for devices that already exist in the market (e.g., a VCR). An intermediate AV (IAV) node is defined for simple devices such as camcorders or DVTRs (e.g., camera). A full AV (FAV) node is defined for devices of more resources, such as IRDs or smart televisions (e.g., DASE set-top-box). An FAV node (or device) typically contains enough hardware to host control modules and to support application programs locally. The IAV devices and FAV devices communicate by sending messages over the home network using a generic message passing system. When new devices join the home network, they are recognized and added to a global name database (registry). The registry holds information about their characteristics and provides a reference to a handler (e.g., communication point) for that device. Other devices and services are able to query the registry to locate a device and then, using the handler, can interact with the device. When a device is initially added to the home network, the system queries the device to ascertain its characteristics and capabilities. Once a device's characteristics are known, the architecture provides suitable and known methods of controlling it.

Legacy devices are devices that were built before the HAVI architecture or devices that select not to use the HAVI architecture. The HAVI architecture supports Legacy devices by providing Legacy DCMs to provide protocol conversions for Legacy devices. These Legacy DCMs can contain sufficient knowledge to allow them to support an existing one or two way control protocol and provide a specific control interface to the devices that conform to the HAVI architecture. A legacy DCM acts as a bridge between the Legacy and HAVI devices. This feature allows the HAVI architecture also to interact with any future device control protocols such as, for example, protocols being used for home energy management or security, etc.

### Appliance and Component Identification

The present invention requires the identification of each content provider contained within the networked or digital television environment, e.g., appliances, broadcast streams, etc. As is known in the art, the identification process of the present invention is achieved by providing an efficient mechanism and method operable within a consumer electronic network that provides an IEEE 1394 communication framework and also provides high level applications with a persistent identifier for devices coupled to the network. This is accomplished using global unique identifiers (GUIDs) assigned to each device of the consumer electronics network. A GUID map is constructed and maintained upon each bus reset that maps GUID values with physical identifier values.

Within the network, several consumer electronics products, e.g., television, VCR, tuner, set-top box (e.g., intelligent receiver/decoder, IRD), DVTRs, PCs, DVD players (digital video disk), etc., can be coupled to communicate together via a standard bus (e.g., IEEE 1394 serial communication bus). This allows devices of the network to control one another and obtain information regarding one another. For example, one communication architecture that may be used is the home audio/visual initiative (HAVI) format as discussed above. The HAVI network offers unique advantages to consumer electronic vendors because the architecture offers for the home network, many of the advantages of existing computer system networks, namely, interconnected devices that can share resources and provide open, well defined Application Program Interfaces or API's that allow ease of development for third party developers. HAVI offers extended interoperability,

To identify each appliance or device in the network, a global unique identifier (GUID) is associated with each device. A low level driver, a link driver, constructs a GUID list including a GUID for each device on the HAVI network. The order of the GUID entries in the GUID list (e.g., the index) matches the physical identifiers assigned to the devices by the IEEE 1394 serial bus. Although the physical identifiers can become reassigned on bus reset, the GUID values are constant. Network-based applications use a device's GUID to communicate therewith. Speed map and topology map information is maintained based on the physical identifier information. Therefore translations between GUIDs and physical identifiers are efficiently performed by the present invention and are used for referencing speed map and topology information for an application program or other object.

The 1394 local bus architecture creates a dynamic network within which a 1394 capable device can be inserted (e.g., hot insertion) at any time and be ready for use. Within the local bus system, a device is identified with a 6-bit physical identification number which is assigned by the local bus upon a bus reset. The physical identification number for a device can change as new devices are added into or existing devices are removed from the network. To provide higher level applications with a persisting identifier for a given device, the GUID (global unique identifier) is employed. The GUID is a unique 64 bit value that contains a vender identification number coupled with a chip series identification number. The GUID is determined (according to IEEE 1212 standards) when an IEEE 1394 capable device is manufactured. Because some bus information, such as speed map and topology map, are referenced by physical identifier values, the present invention provides an efficient mechanism for presenting speed map and topology map information with respect to the corresponding GUID value for a device.

A list of available appliances or devices in the network is information that network-based applications generally request periodically. The present invention generates and maintains a GUID list of all devices of the network and orders the GUID's of the GUID list by their respective physical identifier values. In this manner, the index of a particular GUID within the GUID list is its physical identifier and this index can be obtained and then used to access data from the speed map and topology map data structures which are constructed and maintained with respect to physical identifier values.

The foregoing results in operable recognition or identification of connected appliances or components Specifically, interconnected devices can share resources and provide open, well-defined APIs that allow ease of development for third party developers.

This method of appliance identification is not meant to be limiting as one ordinarily skilled in the art will recognize that alternative means of appliance identification may be incorporated with the technology of the present invention as described herein.

### Appliance and Component Control

The present invention further requires appliance control once identification is achieved. As is also known in the art, appliance control is achieved by providing a home audio visual (AV) network which defines an open architecture for inter-operating CE (consumer electronic) devices in a home network. The interoperability aspects define an architectural model that allows CE devices from any manufacturer to inter-operate and function seamlessly within the user's home AV system. A combination of a base set of generic device controls with a method is used to extend a base control protocol as new features and new CE devices are deployed within the home AV network. In so doing, the architecture is extensible, and can be readily modified and advanced as market requirements and technology change.

The architecture allows all newly coupled device to be queried. Using the results of the query, a software based abstraction of that device is generated and made available to other elements in the network. The software abstraction performs the functionality controlling the devices within the networked environment, which provides a predefined, standardized, set of interoperability, functionality, and control interfaces for the device. The CE device is coupled to and communicates with the home AV network via a device control module. Each CE device in the home AV system has a corresponding device control module (DCM). The DCM may also provide an application programming interface (API) to allow other applications to access and manipulate any newly coupled CE device.

Through the DCMs, over the life time of the AV system, as new devices are added whose capabilities and features are unknown, or only partially known to other devices, a mechanism is provided which guarantees that all devices can be communicated with and controlled at some basic minimal level, and then where possible, as more information is obtained about the device, a better abstraction of the new device is created.

Specifically, when a new device is coupled to a home AV system, a default (referred to as level one) DCM is automatically generated for the new device. A device manager (e.g., a software based control object) executing on one of the devices in the AV system automatically determines the basic characteristics of the device, categorize the device into a class (e.g., which share common features), and initializes a generic, or default, DCM for the device (which corresponds to that class of device). In so doing, the level one DCM ensures that no matter what device is added, the system is able to create a basic level device controller (e.g., level one) and make the device's facilities available to other parts of the system and to the user.

During this initialization phase, if the device is found to contain pseudo code, or a reference to pseudo code, which implements a more capable or a more sophisticated DCM for the device, the device manager retrieves the pseudo code and initializes a DCM based upon the pseudo code. This is referred to as a level 2 DCM. In this case, since such pseudo code is typically provided by the device's manufacturer and is therefore more intimately familiar with the hardware of the device, is able to offer a better software abstraction of the device's capabilities. Depending upon the devices included in the AV system, either, or both, of the DCMs are initialized and instantiated. By making both the level 1, and level 2 DCMs of the present invention available, the system of the present invention ensures that any new devices added to the home network are seamlessly and easily made available to applications, system software, and the consumer. In so doing, an extremely flexible mechanism is created that ensures that not only will new devices become part of the AV system, but that they will be accessed in different ways depending on capabilities of the other devices in the AV system.

In essence, seamless interoperability and integration of a plurality of devices in a network is provided. When a new device is coupled to a home audio video network, the device is queried to obtain a description of first level functions supported by the device. A first level control module which implements the first level functions is generated for the device based upon the description. If the new device contains software for implementing second level functions, the software is retrieved from the device and a second level control module, which implements the second level functions, is generated using the software. The device is subsequently accessed via the control module in order to access the first level functions or the second level functions and provide seamless interoperability and integration of the device with the plurality of devices in the network.

This method of appliance communication is not meant to be limiting, as one ordinarily skilled in the art will recognize that alternative means of appliance communication may be incorporated with the technology of the present invention as described herein.

### Application Program Interface

The present invention utilizes a menu Application Program Interface (“API”) to implement the OmniMenu. API's are well known in the art and comprise the interface by which an application program accesses operating system and other services using calling conventions. An API is defined at the source code level and provides a level of abstraction between the application and the privileged utilities to ensure the portability of the code. API's may also perform the task of translating parameter lists from on format to another and interpreting the call-by-value and call-by-reference arguments in one or both directions.

### OmniMenu Environment

The present invention describes a method and system for creating a single, unified graphical user interface menu, or OmniMenu, within a digital network environment. Specifically, the present invention features a digital broadcast network environment and a single, unified graphical user interface menu for controlling each content provider in the network with the network comprising: a) a plurality of content providers capable of achieving and maintaining interoperability within the digital broadcast network environment, wherein the content providers each contain a series of individual menu items existing at various levels and functioning to control the content providers; b) a digital broadcast rendering device for controlling the interoperability of the content providers existing within said network environment; and c) a single, unified graphical user interface menu, wherein a uniform menu Application Program Interface is utilized to assimilate all of the individual menu items of each content provider within the network to form the single, unified graphical user interface menu. The unified graphical user interface menu is designed to be able to control the each of the content providers at any level. The digital broadcast network environment also comprises a plurality of submenus corresponding to a particular type of content provider, and a plurality of menu items properly categorized within the submenus, wherein the menu items are capable of controlling one or more corresponding features of the content providers.

The present invention further features a method for creating a single, unified graphical user interface menu to control consumer electronics within a networked environment comprising the steps of: a) installing a digital broadcast rendering device having a uniform menu Application Program Interface; b) introducing a plurality of content providers within the networked environment via the digital broadcast rendering device, wherein the content providers contain corresponding individual menu items; c) identifying and controlling each content provider to achieve and maintain interoperability within the networked environment, wherein each individual menu item is registered by the uniform menu Application Program Interface; d) causing the uniform menu Application Program Interface to classify each menu item according to its control function; e) assembling a single, unified graphical user interface menu of all registered individual menu items, wherein the single, unified graphical user interface menu is assembled by causing said uniform menu Application Program Interface to assimilate the registered individual menu items; and f) selecting, for control, the content providers and any of the corresponding menu items within the networked environment from the single, unified graphical user interface menu.

The present invention's menu Application Program Interface (“API”) is designed to create, control, and edit the single, unified graphical user interface menu, or OmniMenu. The functionality of the menu API is similar to that as described above for an API.

The present invention focuses on the human appliance interface (HAI) issues raised when presenting end-users with control of sophisticated home appliances. There is a need for a clear and simple mental model that is implemented through a simple intuitive control system. This need is magnified in the case of a digital broadcast renderer, e.g., a DASE-compliant set-top-box, since in addition to the configuration of numerous appliances, including the set-top-box itself, there is a need to browse through the digital broadcast to determine which services are available and to activate one such service. The said browsing involves browsing through multiple channels and reviewing all the applications available from each channel. Indeed, some broadcast channels may have numerous applications available with these applications each containing content information that may be included within the OmniMenu. Clearly, such browsing is time consuming, potentially confusing, and prone to user error, especially in the probable event that hundreds of channels are available, each delivering several services.

The present invention relieves the burdensome, time consuming, and error prone characteristics often associated with prior art menu environments by combining all menus of all appliances (including the set-top-box, TV, and any networking devices), all available services (whether selected or not), all available events (including co-branded and promoted events), all available channels, and all promoted material into a single OmniMenu environment where any one of the available services may be quickly and easily selected.

Through the use of the present invention defined menu API, all appliances and broadcast applications, upon introduction into the networked environment, are caused to register and construct their individual menus into a single, collectively assembled OmniMenu. This OmniMenu assembly is achieved through a uniform menu API, building on the API as discussed above. The menu API of the present invention enables all controlled hardware, software, and content components to collectively construct a unified view of the available services, and present this view within a single menu. This menu can be updated in real-time, on-the-fly, as new appliances are connected, or with changes in the broadcast content data services.

The OmniMenu of the present invention is unlike prior art standards, such as the HAVI standard, which require that each appliance will be associated with its own menu, with single appliances often having multiple menus. The present invention eliminates the presence of several appliance-specific, or broadcast-specific menus as seen in prior art menu environments.

OmniMenu enables controlling 1) the setting and control of networked appliances; 2) a guide to current programs; 3) information and internet services available, including those not originating from the broadcast, and (4) a set favorites. Each of these is discussed in greater detail below in the context of the particular content providers that are to be used as submenus in a preferred embodiment. These particular submenus, however, are not to be considered limiting, but as examples only to illustrate one embodiment of the present invention.

The menu API of the present invention requires classifying menu items to determine whether they control an appliance (both hardware and software), a tuner, a data service (e.g., to enable list application in non-selected channels), or special promotional materials (e.g., TV shopping coupons). Appliance identification and menu item classification is performed by the means described above.

The API further requires that each menu item is either an individual menu item or a submenu, both having the standard JAVA SWING semantics. The menu API further enables defining show/hide policies, colors, and icons. The API further enables defining custom preview behavior, whereby a small preview window can be used to show video-clips or other animation.

A possible implementation or embodiment of the OmniMenu 10 is depicted in FIG. 1. FIG. 1 depicts OmniMenu 10 having a series of submenus with their respective associated menu items. OmniMenu 10 is shown as appearing in primary display 18 of a digital television environment or display. OmniMenu 10 is overlaid upon primary display 18 with primary display either cancelling or remaining in view. By way of example, OmniMenu 10, as shown in FIG. 1, identifies a particular series of submenus and menu items that can comprise one embodiment of the present invention. OmniMenu 10 may comprise a number of different layouts, each having unique categories of submenus and menu items as needed and desired by the user. Appliance control submenu 20 is a submenu used to control each appliance contained within the networked environment and is shown by way of example. Both the hardware and software aspects of each component attached or contained within the network environment are controlled by appliance control submenu 20. Appliance control submenu 20 provides OmniMenu options that enable controlling all networked appliances. In the present invention, the OmniMenu is updated dynamically as devices are connected or disconnected, and can be controlled by appliances to reflect state changes. Examples of controllable features might include such things as font, color and sound adjustments, etc. Each appliance or component within the systems network is equipped with various options and settings that can be controlled to either enhance or customize the performance of the appliance or component. It is these types of characteristics that are intended to be controlled by appliance control submenu 20.

Once a submenu is selected, a series of individual menu items becomes selectable by the user. These menu items each contain specific content information pertaining to a particular feature of the corresponding content provider. The cluster of menu items, shown generally as 36, added to submenu 20 each represent a separate component. These separate components are shown as menu items 52. Menu items 52 may represent various components such as tape players, CD players, DVD players, a personal computer, stereo receivers, home theater systems, television sets, VCR's, and various other electronic components or equipment. One ordinarily skilled in the art will be able to determine and realize the numerous types of electronic devices that can be included and functional with the technology as described herein. Each menu item 52 listed contains appliance control data that is controllable by the component itself as initiated by the user. The control data includes information pertaining to the appliance's settings and similar information, such as font, sound, color, etc. For example, if the user were to select “TV” then the TV's internal settings could be controlled and customized to the liking of the user.

Another feature of OmniMenu 10 is its ability to dynamically update appliance control submenu 20. As each new appliance or content provider is added to the network, OmniMenu 10, and specifically appliance control submenu 20, is updated dynamically to reflect the addition and connection of the component. In a like manner, as each device is disconnected from the network, the OmniMenu 10 dynamically updates itself and removes the information from appliance control submenu 20. This allows the user to receive accurate and up to date information regarding the network system.

Also shown as menu item 56 is appliance control data containing the “last” menu item selected within menu items 36 of appliance control submenu 20. This allows a user to quickly recall the last menu item 52 and associated appliance control data selected by the user.

Broadcast control submenu 24 used to control the broadcast information contained within menu items 60 and listed generally as menu items 40. Broadcast content data essentially controls the channel being viewed as well as information pertaining to the several other channels. Broadcast content data may include information such as movie channels, network broadcasts, radio programs, cable and satellite programs, sporting events, learning programs, and various other programs capable of being broadcast and received by a broadcast receiving device or renderer. Broadcast control submenu 24 and its associated menu items 60 provides OmniMenu options that enable listing the programs currently in progress, the time duration until their start (for upcoming programs), or until their end (for programs which already started), the rating of the programs, and any other information relevant to the programs available. This information is retrieved through Electronic Program Guide (“EPG”) functionality. Selecting a program amounts to selecting a channel by means of tuning the DASE set top box to the requested channel and displaying the received content on the primary TV display 18. Broadcast control submenu 24 also enables displaying a complete EPG for all future programs and any information associated therewith. The Broadcast control submenu 24, and the broadcast content data contained therein, is fully controlled by the broadcasters and cannot be changed or modified by the user.

Similar to appliance control submenu 20, broadcast control submenu 24 also contains a “last” menu item 64 allowing a user to quickly recall the last menu item 60 and associated broadcast control data selected by the user.

Information services control submenu 28 enables the user to control available information services such as the Internet. Information services control submenu 28 includes a cluster of menu items 68, shown generally as 44, that contain information services data. This data may comprise information pertaining to trading services, email, travel services, and any other type of information service, not to be limited herein. By selecting information services submenu 28, OmniMenu 10 enables the user to select data services, including Xlets and other web-based applications, originating from the Internet. The information content is not limited to the content of the broadcast. Information services submenu 28 enables browsing as well as selecting promotions, such as special deals and coupons. This menu is controlled by the set-top-box manufacturer, as well as by the broadcast promoters.

Again, and similar to appliance control submenu 20 and broadcast control submenu 24, information services control submenu 28 also contains a “last” menu item 72 allowing a user to quickly recall the last menu item 68 and associated information services data selected by the user.

Finally, FIG. 1 also shows end-user control submenu 32. End-user control submenu 32 may be used to cluster and bookmark select events or menu items, shown generally as 48, from any of the available submenu categories as included within OmniMenu 10. For example, as shown in FIG. 1, the user may be able to build end user control submenu 32 to include and bookmark menu items such as menu items 52 (CD and radio) from appliance control submenu 20, menu items 60 (Olympics and movie channel) from broadcast control submenu 24, and menu items 68 (email service) from Information services control submenu 28. This feature functions much like the “bookmark” or “favorites” feature of common web browsers wherein a shortcut is provided to information and/or content sought and frequently used by the user. In addition, end-user control submenu 32 is controlled entirely by the user. In another embodiment, several end user control submenus could be created to cater to the individual likings of several users.

In one of the embodiments, OmniMenu 10 is activated displaying each submenu and its associated menu items on primary display 18. Looking at FIG. 1, shown is the end-user control submenu 32 and its associated menu items 48 highlighted as 80. Specifically, user favorite 52 (video) is shown highlighted as 84, indicating that the appliance control data (i.e. the content information) for that particular menu item is requested. Information pertaining to this particular selection will be viewable in display 88. Likewise, as any of the menu items are selected, their contents is previewed in display 88. This preview of highlighted menu items display 88 is designed to provide the user with information about the service, or particular item chosen in OmniMenu 10 and can be used to determine if that particular selection is wanted. Preview display 88 can also be used to show video clips or other animation depending upon the menu item selected and the content data contained therein.

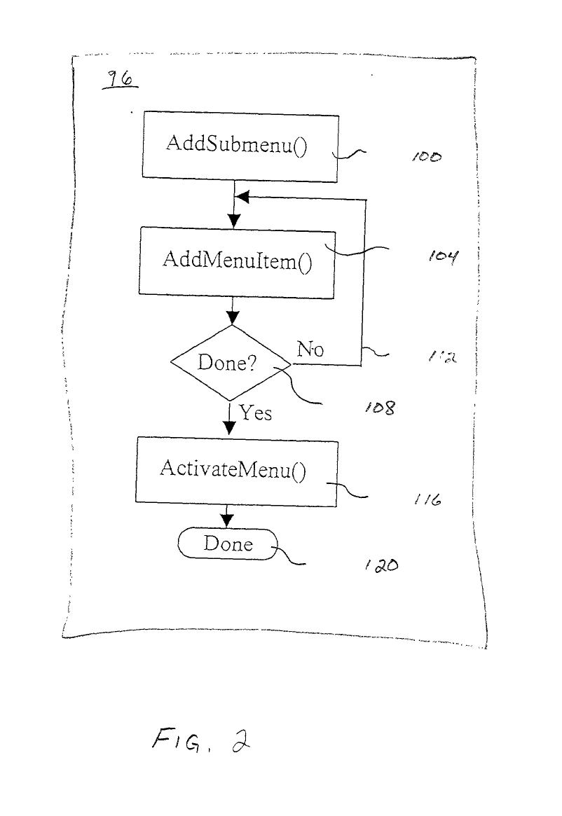

FIG. 2 depicts the menu API message sequence 96 for a content provider, such as an appliance, to add a menu item to the OmniMenu. Prior to adding a menu item, the user is required to add a submenu. The add submenu call 100 prompts the user to add a submenu as further described in greater detail below. Each submenu is added as the user initiates the API message sequence to do so. Following the addition of a submenu, the menu API message sequence 96 continues by prompting the user to add a menu item to the previously added submenu. The add menu item call 104 allows the user to add various menu items to be included and associated with a particular submenu. As stated, each menu item contains specific content information. The arrangement and categorization of each menu item will depend upon the submenu each menu item is to be associated with. After each menu item is added, the menu API sequence 96 then prompts the user to indicate whether other menu items are to be added to the submenu, shown as “Done?” call 108. If the user is not finished adding menu items to the submenu, the user indicates this by selecting “no” from call 108. Any number of menu items may subsequently be added in iterations and in a like manner as indicated by the loop indicator 112. This process continues until the OmniMenu is complete. If no further menu items are to be added at this time, the user indicates this by selecting “yes” from call 108 within the menu API sequence 96. At this time, the submenu just added, with its associated menu items, is activated via the activate menu call 116, and becomes operable within the menu API. In the preferred embodiment, a message-passing approach is used rather than an Object Oriented approach to created OmniMenu 10 because the communication between the devices is assumed to be accomplished by the technique and means of controlling all networked appliances and components as described above. Each of the add submenu call 100, the add menu item call 104, and the activate menu call 116 are discussed in greater detail below.

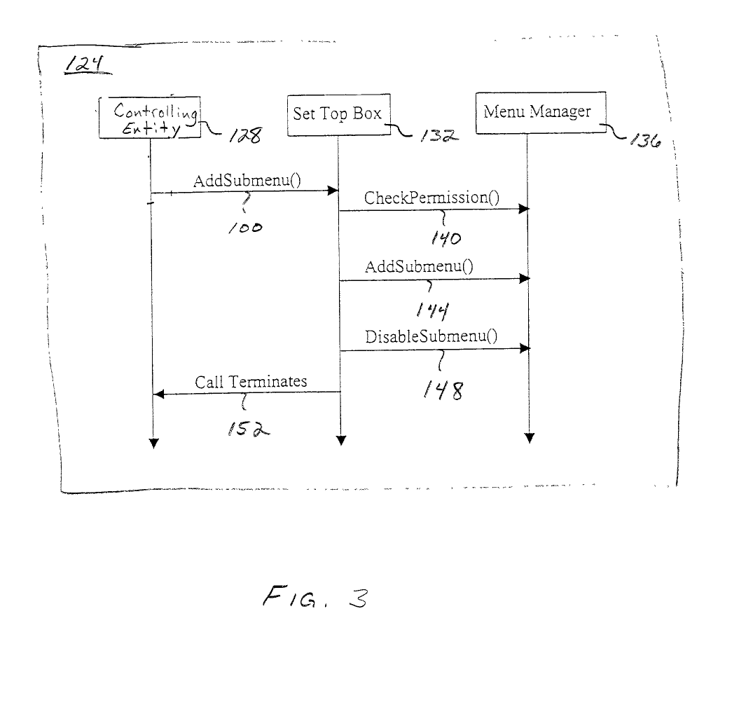

FIG. 3 illustrates in greater detail the call sequence 124 for adding a submenu, which was shown generally as the add submenu call 100 in FIG. 2. As content provider 128 (shown as an appliance, but may also be a broadcast, informational service, etc.) is introduced to the network, the network recognizes and identifies content provider 128 by the means described above. Once introduced and identified, the network recognizes any contained menu information within the content provider. This menu information is identified and categorized as containing either submenu information or individual menu item information. As can be seen from FIG. 3, the add submenu message 100 is sent to the menu manager 136 of the set top box 132 or other graphical user interface rendering module. Menu manager 136 checks whether permission to add the submenu is granted as shown by the check permission call 140. If permission is granted, the submenu is added to the OmniMenu. However, because of the incompleteness of the submenu when first added to the OmniMenu, due to a lack of associated menu items, the add submenu call sequence 124 includes a disable submenu call 148 designed to immediately disable the submenu so as to avoid display of an incomplete menu. In other words, only those submenu items having or containing information as individual menu items are displayed in the OmniMenu display environment. Once the submenu is added and disable submenu call 148 disables the submenu, the sequence is terminated via call terminate 152. This may be represented by user input indicating that the add submenu call sequence 124 is finished.

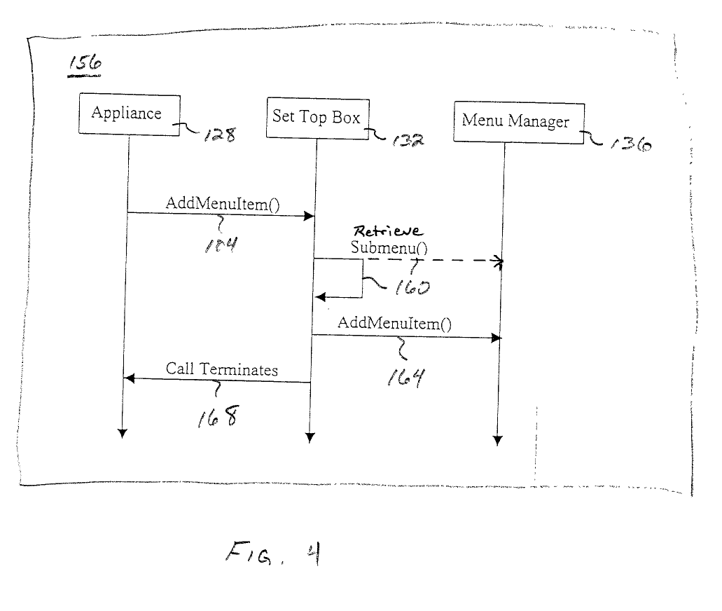

FIG. 4, illustrates the individual menu item call sequence 156 for adding an individual menu item. Similar to the add submenu call sequence described in FIG. 3, menu item call sequence 156 causes an add menu item call 104 to be sent to menu manager 136 of set top box 132 or other connected graphical user interface rendering module. The add menu item call instructs menu manager 136 to retrieve the required submenu object. This is shown as retrieve submenu call 160. Retrieve submenu call 160, as is shown, may be repeated as often as necessary to correctly categorize each individual menu item identified in the network. Once menu manager 136 retrieves the submenu, menu manager 136 initiates the add menu item call, shown as 164 due to its subsequent use in the sequence, which causes the particular menu item to be added to the submenu retrieved. Once the menu item is added to the submenu, the sequence is terminated via call terminate 168.

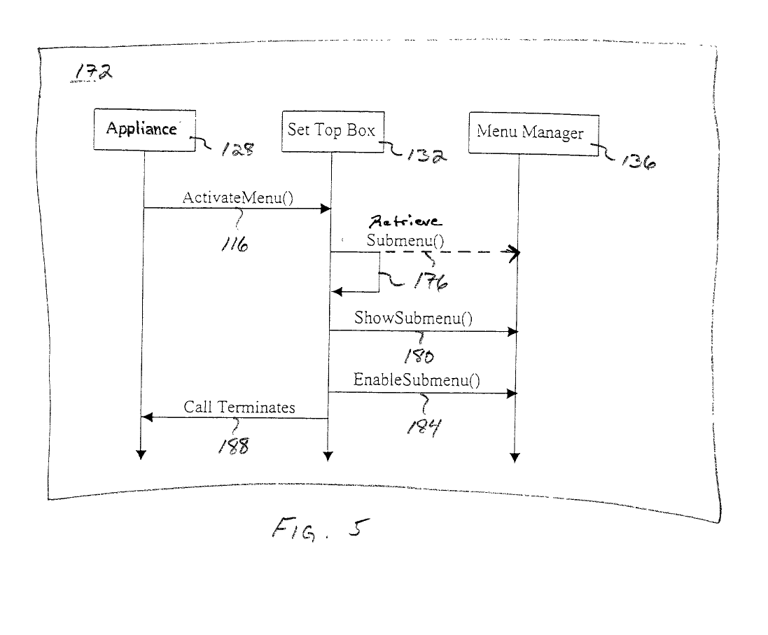

FIG. 5, illustrates the menu activation call sequence 172. Shown is an appliance content provider 128 for illustration purposes only. The activate Menu call 116 is sent to the menu manager 136 of the set top box 132 or other graphical user interface rendering module. Again, the retrieve submenu call 176 is activated which indicates which submenu has been selected for activation. Once selected or retrieved, menu manager 136 causes show submenu call 180 to display the submenu and its associated menu items. Subsequently, menu manager initiates the enable submenu call 184 which causes the submenu to become active within the OmniMenu display environment, thus allowing user input such as selecting a menu item or performing a task that is the subject of a menu item. This process can be repeated as often as necessary to activate subsequent submenus and their associated menu items. Once the submenu is activated, menu activation call sequence is terminated via call terminate 188.

It should be noted that activation may only occur once the submenu is complete, or has menu items associated therewith as any submenu incomplete will remain inactive within the system. As menu manager 136 retrieves the submenu, the submenu will displayed over the primary television display where a user may initiate input to select and/or perform the functions that are the subject of the menu items associated with the submenu only if the submenu is active and contains relevant content data within a series of menu items.

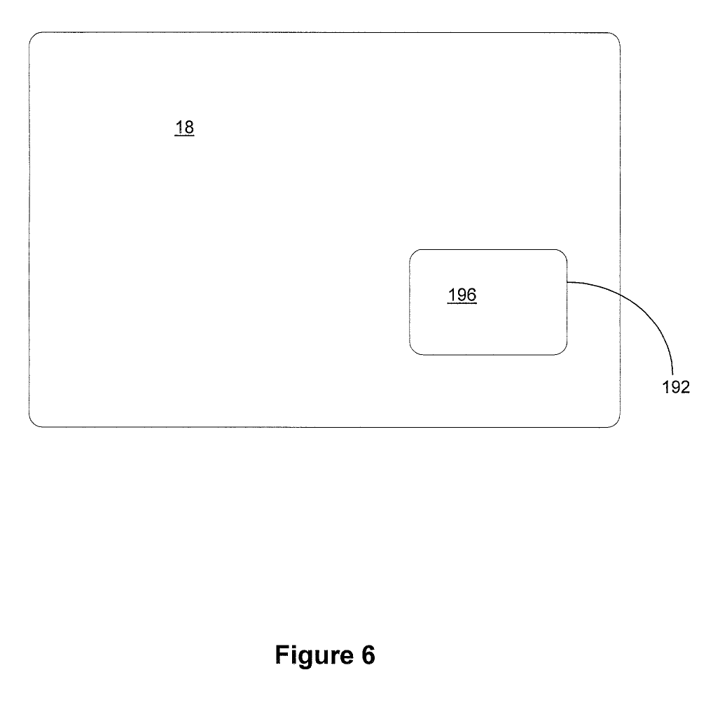

FIG. 6 illustrates another embodiment of the present invention wherein OmniMenu may be used to display various types of information. As shown, secondary display 192 is within the primary display 18 environment. Secondary display 192 may be used to display several different types of content information pertaining to other services, broadcasts, etc., such as program guides for cross-promoted programs, or polling information where polls may be taken and the results displayed. It will be recognized that numerous types of content information may be displayed herein depending upon the menu item selected and the manner in which viewing that menu item is desired. As such, the possibilities for the types of informational content that may be displayed is not to be limited, but is to cover the expansive possibilities of information that may be received into the networked environment from any of the available sources or content providers. One ordinarily skilled in the art will recognize the numerous possibilities that exist upon the implementation of an OmniMenu into a consumer electronics network environment.

The technology of the present invention may also be incorporated into and integrated with a content proxy data structure technology.

Because of the unique functionality of the Application Program Interface, the present invention also features a computer-readable memory configured so that it can direct a computer, contained within a consumer electronic network environment, to perform several functions. These functions include, but are not limited, directing a computer to receive content information from a content provider into a digital broadcast rendering device, where the content information is in the form of menu items; to register these menu items via the uniform menu Application Program Interface; to classify the menu items into submenus and menu items according to their control functions; to assemble a single, unified graphical user interface menu of all registered individual menu items by causing the uniform menu Application Program Interface to assimilate the registered individual menu items into the single, unified graphical user interface menu; and to allow a user to the access the content information and control any of the content providers within the network environment directly and effortlessly from the single, unified graphical user interface menu.

In addition, the present invention's menu Application Program Interface contains unique message sequencing abilities in that it may assemble a single, unified graphical user interface menu by identifying and controlling a plurality of content providers to achieve and maintain interoperability within a networked environment, wherein the content providers each have respective individual menu items containing content information enabling control of that particular content provider; by registering the individual menu items with the Application Program Interface; by classifying the individual menu items, according to their respective control function, as either submenus or menu items; and by assimilating the menu items into a single unified graphical user interface menu. The assimilation is accomplished by initiating a message sequence to a) add a submenu to the single, unified graphical user interface menu, with each submenu corresponding to a particular category of content providers; b) add at least one menu item to the submenu; and c) activate the submenu to enable viewing and selection of the submenu and the menu items contained therein.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A digital broadcast network environment comprising:
a) a plurality of content providers capable of achieving and maintaining interoperability within said digital broadcast network environment, said content providers each containing a series of individual menu items existing at various levels and functioning to control said content providers;
b) a digital broadcast rendering device for controlling the interoperability of said content providers existing within said network environment, said digital broadcast rendering device itself also existing as a said content provider; and
c) a single, unified graphical user interface menu, wherein a uniform menu Application Program Interface is utilized to assimilate said individual menu items of said content providers to form said single, unified graphical user interface menu, said unified graphical user interface menu capable of controlling said individual menu items of said content providers at any level.

2. The digital broadcast network environment of claim 1, wherein said unified graphical user interface menu further comprises:
a) a plurality of submenus corresponding to a particular type of said content provider; and
b) a plurality of menu items properly categorized within said plurality of submenus, said menu items capable of controlling one or more corresponding features of said content provider.

3. The digital broadcast network environment of claim 2, wherein said unified graphical user interface menu further comprises a customizable preview display for previewing the contents of a highlighted menu item prior to selecting said menu item.

4. The digital broadcast network environment of claim 1, wherein said digital broadcast network environment is a Digital TV Application Software Environment.

5. The digital broadcast network environment of claim 1, wherein said digital broadcast rendering device is a Digital TV Application Software Environment set top box.

6. The digital broadcast network environment of claim 1, wherein said plurality of content providers comprise several different types of content providers.

7. The digital broadcast network environment of claim 6, wherein said type of content provider comprises a plurality of appliances connected to said network, said appliances capable of achieving and maintaining interoperability within said network environment, said appliances containing a series of individual menu items designed to control a corresponding feature of said appliance.

8. The digital broadcast network environment of claim 6, wherein said type of content provider comprises at least one digital broadcast, said digital broadcast containing a series of individual menu items designed to control a corresponding feature of said digital broadcast.

9. The digital broadcast network environment of claim 8, wherein said digital broadcast contains promotional and other broadcastable content to be displayed within said unified graphical user interface menu.

10. The digital broadcast network environment of claim 9, wherein said digital broadcast comprises multiple channels with each of said multiple channels comprising multiple application services.

11. The digital broadcast network environment of claim 10, wherein said multiple application services each comprise corresponding individual menu items designed to control a corresponding feature of said application service.

12. The digital broadcast network environment of claim 6, wherein said type of content provider comprises at least one informational service, said informational service containing a series of individual menu items designed to control a corresponding feature of said informational service.

13. The digital broadcast network environment of claim 12, wherein said informational service comprises multiple applications.

14. The digital broadcast network environment of claim 13, wherein said multiple applications each comprise individual menu items designed to control a corresponding feature of said application.

15. The digital broadcast network environment of claim 14, wherein said informational service comprises the global informational service of the Internet.

16. The digital broadcast network environment of claim 6, wherein said type of content provider comprises an end-user control, said end-user control content containing a series of individual menu items designed to control a corresponding feature of said end-user control.

17. The digital broadcast network environment of claim 1, further comprising a secondary display, wherein said content contained in a menu item may be displayed onto a primary viewing area.

18. A method for creating a single, unified graphical user interface menu to control consumer electronics within a networked environment comprising the steps of:
a) installing a digital broadcast rendering device having a uniform menu Application Program Interface;
b) introducing a plurality of content providers within said networked environment via said digital broadcast rendering device, said content providers containing corresponding individual menu items;
c) identifying and controlling said content providers to achieve and maintain interoperability within said networked environment, wherein said individual menu items are registered by said uniform menu Application Program Interface;
d) causing said uniform menu Application Program Interface to classify said menu items according to their control function;
e) assembling a single, unified graphical user interface menu of all registered individual menu items, said single, unified graphical user interface menu assembled by causing said uniform menu Application Program Interface to assimilate said registered individual menu items into said single, unified graphical user interface menu; and
f) selecting, for control, said content providers and said corresponding menu items within said networked environment from said single, unified graphical user interface menu.

19. The method of claim 18, further comprising the step of dynamically updating said single, unified graphical user interface menu upon the addition, change, or removal of a said content provider to reflect such changes.

20. The method of claim 18, wherein said step of identifying and controlling said content providers to achieve and maintain interoperability within said networked environment includes classifying said menu items as either submenus or menu items.

21. The method of claim 20, wherein said step of assembling said single, unified graphical user interface menu further comprises the step of initiating a message sequence of said menu Application Program Interface to:
a) add a submenu to said single, unified graphical user interface menu, said submenu corresponding to a particular category of said content providers;
b) add at least one menu item to said submenu; and
c) activate said submenu to enable viewing and selection of said submenu.

22. The method of claim 21, further comprising the step of initiating a message sequence of said menu Application Program Interface to add, in iterations, corresponding menu items to said submenu prior to said step of activating said submenus, said step of activating occurring only after at least one of said menu items have been added.

23. The method of claim 22, wherein said steps are repeated as often as necessary to add multiple submenus and corresponding menu items.

24. The method of claim 21, wherein said step of initiating a message sequence of said menu Application Program Interface to add a submenu further comprises the steps of:
a) sending an add submenu message to a menu manager contained within said digital broadcast rendering device;
b) causing said menu manager to check whether permission is granted;
c) adding said submenu to said single, user graphical user interface menu if said menu manager determines permission is granted;
d) disabling said submenu until said corresponding menu items are added; and
e) terminating said message sequence.

25. The method of claim 21, wherein said step of initiating a message sequence of said menu Application Program Interface to add a menu item further comprises the steps of:
a) sending an add menu item message to a menu manager contained within said digital broadcast rendering device;
b) causing said menu manager to retrieve the appropriate submenu within said single, user graphical user interface menu;
c) adding said menu item to said appropriate submenu; and
d) terminating said message sequence.

26. The method of claim 21, wherein said step of initiating a message sequence of said menu Application Program Interface to activate said submenu further comprises the steps of:
a) sending an activate menu message to a menu manager contained within said digital broadcast rendering device;
b) causing said menu manager to retrieve a selected submenu within said single, user graphical user interface menu;
c) causing said menu manager to display said selected submenu and its corresponding menu items;
d) causing said menu manager to enable said submenu, wherein said submenu is activated such that user input may be received to select one or more of said corresponding menu items contained within said submenu.
e) terminating said message sequence.

27. The method of claim 20, wherein said submenus correspond to content provider types selected from the group consisting of appliance control, broadcast control, information control, and end-user control.

28. The method of claim 18, wherein said step of selecting said content providers includes selecting an appliance content provider and corresponding menu items to control the setting and control of said appliance.

29. The method of claim 18, wherein said step of selecting said content providers includes selecting a broadcast content provider and corresponding menu items, wherein said broadcast content provider is controlled by a broadcast source entity.

30. The method of claim 29, wherein said step of selecting said content providers includes selecting a broadcast content provider to control an Electronic Program Guide, wherein a user may select and view current running programs as well as any information pertaining to said programs.

31. The method of claim 18, wherein said step of selecting said content providers includes selecting an informational service content provider.

32. The method of claim 18, wherein said step of selecting said content providers includes selecting an end-user content provider to customize said single, unified graphical user interface menu.

33. The method of claim 18, wherein said networked environment is a Digital TV Application Software Environment.

34. The method of claim 187, wherein said digital broadcast renderer is a Digital TV Application Software Environment set-top-box.

35. A method for displaying a single, unified graphical user interface menu within a consumer electronic network environment comprising:
a) displaying a series of submenus corresponding to a type of content provider, said submenus containing respective assimilated menu items obtained from each of said content providers introduced within said consumer electronic network environment; and
b) displaying at least one of said menu items upon the selection of one of said series of submenus, said menu items containing content information corresponding to a particular feature of said content provider.

36. The method of claim 35, further comprising the step of displaying said content information within a customizable preview display.

37. The method of claim 35, further comprising the step of displaying said content information in a secondary display overlaid upon a primary display.

38. A computer-readable memory configured so that it can direct a computer, contained within a consumer electronic network environment:
a) to receive content information from a content provider into a digital broadcast rendering device, said content information is in the form of menu items;
b) to register said menu items via a uniform menu Application Program Interface;
c) to classify said menu items into submenus and menu items according to their control functions;
d) to assemble a single, unified graphical user interface menu of all registered individual menu items by causing said uniform menu Application Program Interface to assimilate said registered individual menu items into said single, unified graphical user interface menu; and
e) to allow a user to access said content information and control any of said content providers within said network environment from said single, unified graphical user interface menu.

39. A method for causing an Application Program Interface to assemble a single, unified graphical user interface menu, said method comprising the steps of:
a) identifying and controlling a plurality of content providers to achieve and maintain interoperability within a networked environment, said content providers having respective individual menu items containing content information enabling control of said content provider;
b) registering said individual menu items with said Application Program Interface;
c) classifying said individual menu items, according to their respective control function, as either submenus or menu items;
d) assimilating said menu items into a said single unified graphical user interface menu by initiating a message sequence to:
i) add a said submenu to said single, unified graphical user interface menu, said submenu corresponding to a particular category of said content providers;
ii) add at least one menu item to said submenu; and
iii) activate said submenu to enable viewing and selection of said submenu.
